(19) United States
(12) Patent Application Publication
(10) Pub. No.: US 2009/0223327 A1
(43) Pub. Date: Sep. 10, 2009

(54) WRENCH SOCKET ASSEMBLY HAVING TWO FORMS OF USAGE

(76) Inventor: Hsiu-Nien Lin, Dali City (TW)

Correspondence Address: Dr. BANGER SHIA;Int''l Patent Office of Bang Shia, 102 Lindencrest Ct, Sugar Land, TX, 77479-5201, US

(21) Appl. No.: 12/334,516

(22) Filed: Dec. 14, 2008

(30) Foreign Application Priority Data
Mar. 7, 2008 (TW) 097203831

(51) Int. Cl. B25B 13/06

(52) U.S. Cl. 81/121.1

(57) ABSTRACT

The present invention provides a wrench socket assembly. The socket assembly includes an anchor pin and a socket. The anchor pin can be fixed in the socket or can be pulled slightly from the socket to sway at a predetermined range when in use.

### BACKGROUND OF THE INVENTION

1. Field of the Invention

The present invention relates to a wrench socket assembly which has two forms of usage.

2. Description of the Prior Art

As disclosed in the patent of Taiwan application No. 091209587, a wrench socket assembly includes a socket with a receiving hole and a sleeve with a ball member corresponding to the receiving hole. The ball member as well as a spring is installed in the receiving hole, while there are several through holes disposed on the socket and the ball member for a pin to pierce therethrough. Therefore, universal rotation of the sleeve can be achieved.

However, the socket assembly has so many parts that the overall manufacturing cost and time thereof cannot be lowered, which is unwilling to be seen by the manufacturer.

To mitigate the above-mentioned disadvantages, the patent of Taiwan application No. 094216591 provides another wrench socket assembly, which includes a socket with a receiving hole and an anchor pin. The anchor pin is installed in the receiving hole, and the opening of the receiving hole is, thereafter, narrowed by stamping manner.

A further disadvantage is that, the mechanical strength of the socket is sacrificed due to the stamping procedure, which may cause chinks on the socket.

The present invention has arisen to mitigate and/or obviate the afore-described disadvantages.

### SUMMARY OF THE INVENTION

The main object of the present invention is to provide a wrench socket assembly which has two forms of usage.

Another object of the present invention is to provide a wrench socket assembly which has fewer parts while maintaining sustainable mechanical strength.

To achieve the above objects, a wrench socket assembly is provided. The socket assembly includes an anchor pin and a socket. The anchor pin has a driving member and a connecting member. The connecting member is disposed an engaging body, and a portion of the anchor pin close to the connecting member is disposed an annular flange. Between the annular flange and the connecting member is disposed a neck, around which a positioning body is disposed. Moreover, a portion of the connecting member close to the neck is an arc surface, and a portion of the connecting member away from the neck is a polyhedral inclined surface. Furthermore, the socket has a receiving hole to receive the connecting member therein, and around an opening of the receiving hole is an annular wall to engage with the annular flange. In addition, a side wall of the receiving hole has a shallow notch corresponding to the engaging body and an annular groove to receive the positioning body.

One of the usage forms in accordance with the present invention is that: when the annular flange engages with the annular wall, the engaging body is received in the shallow notch; further due to the receiving hole and the connecting member being formed in correspondingly polyhedral structures, the anchor pin is, therefore, fixed in the socket so that the anchor pin and the socket can rotate simultaneously. The other usage form in accordance with the present invention is that: when the anchor pin is pulled slightly to disengage the annular flange from the annular wall and to engage the positioning body with the arc surface of the connecting member, the engaging body is urged back into the side hole so as to enable the anchor pin to sway at a predetermined range.

The wrench socket assembly of the present invention is designed to realize the follow efficacy:

1. The socket assembly provides two usage forms. When the anchor pin is pulled slightly from the socket, the connecting member engages with the positioning body, enabling the anchor pin to turn to desired angles when in use. And when the anchor pin is pushed into the socket, the annular member engages the annular wall and the engaging body is urged into the shallow notch, such that the anchor pin is fixed in the socket, so as to function as a normal wrench adapter.

2. The anchor pin of the present invention is prevented from departing from the socket by the cooperation of positioning body and the connecting member rather than by the stamping manner or the installation of additional parts as prior art does. Therefore, the sustainable mechanical strength is maintained with lower manufacturing cost.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a breakdown drawing showing a wrench socket assembly in accordance with a preferred embodiment of the present invention;

FIG. 1A is a partial profile of a connecting member in accordance with a preferred embodiment of the present invention;

FIG. 2 is a perspective drawing in accordance with a preferred embodiment of the present invention;

FIG. 3 is a diagram showing a wrench socket assembly when an anchor pin is pushed into a socket;

FIG. 4 is a diagram showing a wrench socket assembly when an anchor pin is pulled slightly from a socket;

FIG. 5 is a diagram showing a range at which an anchor pin rotates.

### DETAILED DESCRIPTION OF THE PREFERRED EMBODIMENTS

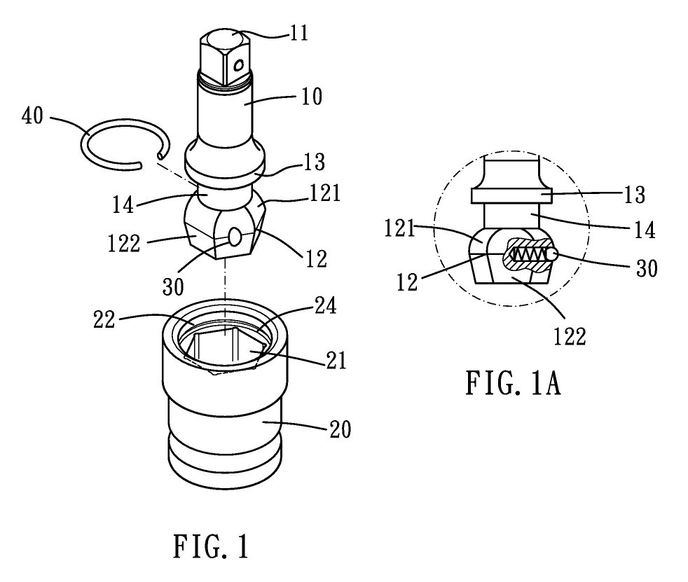

Please refer to FIG. 1 and FIG. 1A. A wrench socket assembly includes an anchor pin 10 and a socket 20. The anchor pin 10 has two ends, one end thereof is a driving member 11, and the other end thereof is a connecting member 12. Both the driving member and the connecting member of the present embodiment are formed in hexagonal shape, yet they can still be formed in other shape as desired. The connecting member 12 has a side hole to receive a resilient body and an engaging body 30, and the engaging body 30 is urged out of the side hole by the resilient body. A portion of the anchor pin 10 close to the connecting member 12 is disposed an annular flange 13, and between the annular flange 13 and the connecting member 12 is disposed a neck 14, around which a positioning body 40 is disposed. In addition, a portion of the connecting member 12 close to the neck 14 is an arc surface 121, and a portion of the connecting member 12 away from the neck 14 is a polyhedral inclined surface 122.

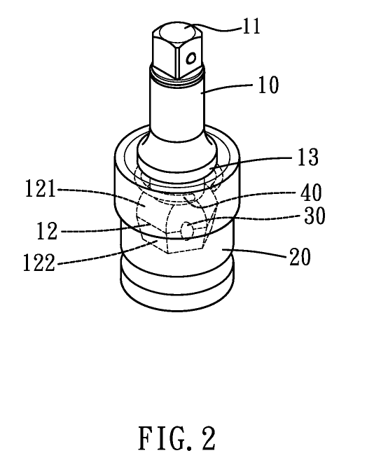

Furthermore, one end of the socket 20 can be a connecting end or a sleeve end, and the other end of the socket 20 is formed a receiving hole 21 to receive the connecting member 12 therein. Around an opening of the receiving hole 21 is an annular wall 22 to engage with the annular flange 13. A side wall of the receiving hole 21 has a shallow notch 23 to receive the engaging body 30 when the annular flange 13 engages with the annular wall 22; and an annular groove 24 to receive the positioning body 40 when the anchor pin 10 is installed in the socket 20. Whereby, when the connecting member 12 is installed into the receiving hole 21, the socket 20 and the anchor pin 10 is combined as show in FIG. 2.

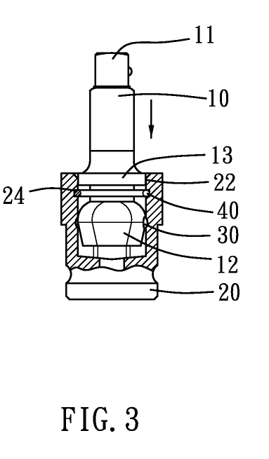

Thus the socket assembly of the present invention has two forms of usage. Please refer to FIG. 3. When the annular flange 13 engages with the annular wall 22, the engaging body 30 is urged into the shallow notch 23, and further due to the receiving hole 21 and the connecting member 12 being formed in correspondingly polyhedral structures, the anchor pin 10 is, therefore, fixed in the socket 20 so that the anchor pin 10 and the socket 20 can rotate simultaneously.

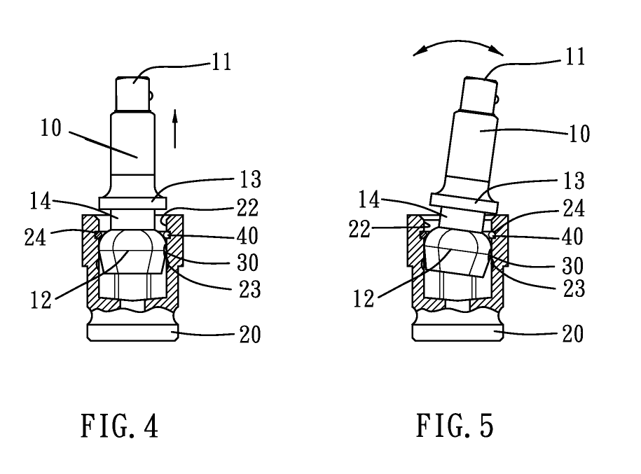

Further refer to FIG. 4 and FIG. 5. As soon as the anchor pin 10 is pulled slightly from the socket 20, the positioning body 40 engages with the arc surface 121 so as to prevent the anchor pin 10 from departing from the socket 20. Meanwhile, the engaging body 30 slides out of the shallow notch 23 and is urged back into the side hole of the connecting member 12, such that the anchor pin 10 is capable of swaying at a predetermined range. More specifically, the anchor pin 10 can sway freely till the neck 14 engages the upper inclined surface of the annular wall 22 or the polyhedral inclined surface 122 engages the side wall of the receiving hole 21. In addition, the anchor pin 10 can rotate smoother due to the deployment of the arc surface 121.

What is claimed is:

1. A wrench socket assembly is provided, comprising:
an anchor pin, one end thereof being a driving member, another end thereof being a connecting member, the connecting member having a side hole to receive a resilient body and an engaging body, a portion of the anchor pin close to the connecting member being disposed an annular flange, between the annular flange and the connecting member being disposed a neck, around which a positioning body being disposed;
a socket, one end thereof being formed a receiving hole to receive the connecting member therein, around an opening of the receiving hole being an annular wall to engage with the annular flange;
when the annular flange engaging with the annular wall, the anchor pin being fixed in the socket, and when the anchor pin being pulled slightly to disengage the annular flange from the annular wall, the anchor pin being swayable at a predetermined range.

2. The wrench socket assembly according to claim 1, wherein a side wall of the receiving hole having a shallow notch corresponding to the engaging body.

3. The wrench socket assembly according to claim 1, wherein a side wall of the receiving hole having a annular groove to receive the positioning body when the anchor pin being installed in the socket.

4. The wrench socket assembly according to claim 1, wherein a portion of the connecting member close to the neck being an arc surface, and a portion of the connecting member away from the neck being a polyhedral inclined surface.
